(19) United States
(12) Patent Application Publication
(10) Pub. No.: US 2023/0117319 A1
(43) Pub. Date: Apr. 20, 2023

(54) Method for Operating a Temperature-Control Fan

(71) Applicant: Gentherm GmbH, Odelzhausen (DE)

(72) Inventors: Alexander Rappl, Königsbrunn (DE); Jochen Pfaff, Eching/Dietersheim (DE)

(21) Appl. No.: 17/908,300

(22) PCT Filed: Mar. 8, 2021
(86) PCT No.: PCT/DE2021/000045

§ 371 Date: Aug. 31, 2022

(30) Foreign Application Priority Data
Mar. 10, 2020 (DE) 10 2020 001 527.1

(51) Int. Cl. B60H 1/00

(52) U.S. Cl. CPC B60H 1/00878; B60H 1/00735; B60H 1/00285

(57) ABSTRACT

A method for operating a temperature control fan integrated in an air guiding system, the method includes steps of: determining a current volume flow generated by a flow generator of the temperature-control fan within a detection region, and then adjusting at least one operating parameter of the temperature-control fan according to the determined current volume flow within the detection region.

### CROSS REFERENCE TO RELATED APPLICATIONS

This application is a US National Stage Entry of PCT/DE2021/000045 filed on Mar. 8, 20221, which claims priority to DE 10 2020 001 527.1 filed on Mar. 10, 2020, all of which are hereby incorporated by reference herein for all purposes.

### FIELD

The invention relates to a method for operating a temperature-control fan integrated in an air guiding system comprising the step: determining a current volume flow generated by a flow generator of the temperature-control fan within a detection region.

The invention further relates to a temperature-control fan having a flow generator for generating a volume flow in an air guiding system and a detection device for detecting a current volume flow generated by the flow generator within a detection region.

### BACKGROUND

Temperature-control fans are employed in various fields of application for generating pre-heated or pre-cooled air flows. Classic fields of application for such a temperature-control fan are in the automobile industry, in particular. For example, temperature control fans are used as neck-warmers in convertible seats. The use of generic temperature-control fans is also known in connection with vehicle air conditioning systems.

User expectations for the fan control continue to grow, in particular for vehicle-specific applications. For example, the operation of the temperature-control fan should adapt to changing operating conditions as rapidly as possible. In practice, it has been found that the temperature-control fans used to date do not react adequately to fluctuations in counterpressure caused by partial blockage of the air guiding system. These fluctuations in counterpressure can lead to incorrect heating or cooling of the air flow due to the air throughput varying because of the blockage.

### SUMMARY

The underlying object of the invention is thus to reduce the effect of fluctuations in counterpressure on the temperature control of an air flow by means of a temperature-control fan.

This object is attained using a method of the type cited in the foregoing, wherein in the context of the inventive method at least one operating parameter of the temperature-control fan is adjusted according to the volume flow detected in the detection region.

The invention makes use of the understanding that when controlling heating and cooling of air, it is possible to compensate for the effect of fluctuations in counterpressure by taking into account changes in volume flow within a detection region. These fluctuations in counterpressure can be caused, for example, by a partial blockage of an air guiding line of the air guiding system or by a partial blockage of an air outlet of the air guiding system. By taking into account the change in volume flow during the adjustment of at least one operating parameter of the temperature-control fan, it is possible to effectively prevent overheating of the volume flow generated by the flow generator, so that greater thermal comfort can be provided during the operation of the temperature-control fan, even when there are fluctuations in counterpressure. In addition, no critical temperatures are generated, so that operating reliability is increased. The inventive method provides energy-efficient thermal comfort for the user.

The flow generator can be, for example, a fan, in particular an axial fan or a radial fan. The detection region in which the fluctuations in counter pressure are detected can be disposed within the temperature-control fan or outside of the temperature-control fan. The detection region in which the fluctuations in counterpressure are determined is disposed, for example, within the air guiding system in which the temperature-control fan is integrated.

In one preferred embodiment of the inventive method, one or more operating parameters of the flow generator that are dependent on the current flow resistance of the air guiding system are determined. The flow resistance of the air guiding system can change, for example, due to a partial blockage of an air guiding line or an air outlet of the air guiding system. Preferably the current volume flow is determined based on the determined one or more operating parameters of the flow generator. Fluctuations in counterpressure are detected using the one or more operating parameters of the flow generator that are dependent on the current flow resistance of the air guiding system, so that the operating parameters of the temperature-control fan can be adapted in a manner specific to the counterpressure. Thus, the current volume flow is determined according to the counterpressure. The one or more operating parameters of the flow generator are preferably determined during constant control of the flow generator. If the flow generator is controlled constantly, for example using a constant power supply, it is possible to assure that changes in volume flow in the detection region occur due to fluctuations in counterpressure in the air guiding system.

In one further preferred embodiment of the inventive method, the current volume flow is determined by comparing the one or more determined operating parameters of the flow generator to one or more reference values. The one or more reference values are preferably operating parameters for the flow generator that relate to a specific state, for example the free-blowing or unblocked initial operating state, of the air guiding system and/or temperature-control system. If the one or more determined operating parameters of the flow generator differ from the parameter values in the free-blowing or unblocked initial operating state of the air guiding system or temperature-control fan, it can be assumed that the flow resistance has increased due to a partial blockage. There is a change in the volume flow within the air guiding system due to the partial blockage of the air guiding system, so that further operating parameters of the temperature-control fan are to be adapted to the change in the volume flow.

In addition, an inventive method is preferred in which the flow generator is driven in a rotational manner and one determined operating parameter of the flow generator that is dependent on the current flow resistance is the current speed of the flow generator. The reference value to which the current speed of the flow generator is compared for determining the current volume flow is preferably a reference speed of the flow generator that relates to a specific state, for example, the free-blowing or unblocked initial operating state of the air guiding system and/or the temperature-control fan. If the flow generator is a radial fan, the speed of the radial ventilator increases as the flow resistance increases. If the flow generator is an axial fan, the speed of the axial fan decreases as the flow resistance increases. Thus, the flow resistance of the air guiding system can be determined using the speed of the axial fan, so that fluctuations in counterpressure can be identified.

Moreover, one inventive method is preferred in which the flow generator is driven electrically. One determined operating parameter of the flow generator that is dependent on the current flow resistance of the air guiding system can be the current consumption of the flow generator and/or the electrical voltage applied to the current flow generator. Furthermore, one determined operating parameter of the flow generator that is dependent on the current flow resistance of the air guiding system can be the current power consumption of the flow generator and/or the current temperature of the supplied air in the flow generator. The reference value to which the current consumption of the flow generator is compared for determining the current volume flow is preferably a reference current consumption value of the flow generator that relates to a specific state, for example, the free-blowing or unblocked initial operating state, of the air guiding system and/or the temperature-control fan. The reference value to which the electrical voltage applied to the flow generator is compared for determining the current volume flow is preferably a reference voltage value of the flow generator that relates to a specific state, for example the free-blowing or unblocked initial operating state, of the air guiding system and/or temperature-control fan. The reference value to which the current power consumption of the flow generator is compared for determining the current volume flow is preferably a reference power consumption value of the flow generator that relates to a specific state, for example the free-blowing or unblocked initial operating state, of the air guiding system and/or temperature-control fan. If the flow generator is a radial fan, the power consumption of the radial fan decreases as the flow resistance increases. If the flow generator is an axial fan, the power consumption of the axial fan increases as the flow resistance increases.

In another preferred embodiment of the inventive method, adjusting the at least one operating parameter of the temperature-control fan comprises adapting the temperature-control performance of a temperature-control device of the temperature-control fan and/or adapting the speed of the flow generator. The temperature-control device can be an electrically operated temperature-control device, in particular an electrically operating cooling and/or heating device. The temperature-control performance can be heating or cooling. The temperature-control device can comprise one or a plurality of thermoelectric devices. By adapting the temperature-control performance, an intended temperature of the volume flow exiting from the air guiding system can be maintained, even if there is a change in the volume flow due to fluctuations in counterpressure. The temperature-control performance is thus adapted to the prevailing volume flow as needed and thus is adapted taking into account fluctuations in counterpressure.

The inventive method is furthermore advantageously further refined in that exceeding a flow resistance limit and/or a counterpressure limit is detected based on the one or more operating parameters of the flow generator. A blockage of the air guiding system outside a tolerance range can be detected by detecting when a flow resistance limit and/or a counterpressure limit is exceeded. In this case, for example, a warning message can be output to a control device of a vehicle. Alternatively, or in addition, a visual and/or acoustic notification can be output to the vehicle driver, informing the vehicle driver of the blockage of the air guidance system outside a tolerance range.

The object underlying the invention is furthermore attained using a temperature-control fan of the type cited in the foregoing, wherein the control device of the temperature-control fan is designed to adjust at least one operating parameter of the temperature-control fan according to the volume flow detected within the detection region.

Furthermore, an inventive temperature-control fan is preferred in which the flow generator is a radial fan or an axial fan. The flow generator is preferably an electrically operated flow generator, wherein the volume flow generated by the flow generator can be adjusted by adapting the power supply. In particular, the flow generator has a fan wheel that during operation executes a rotational movement about an axis of rotation.

Furthermore, advantageous is an inventive temperature-control fan in which the detection device is designed to detect one or more operating parameters of the flow generator that are dependent on the current flow resistance of the air guiding system. The detection device preferably comprises an electronic data processing device designed to determine the current volume flow based on the one or more determined operating parameters of the flow generator. The detection device is preferably designed to calculate the current volume flow based on the one or more determined operating parameters of the flow generator.

In one refinement of the inventive temperature-control fan, the electronic data processing device is designed to determine the current volume flow by comparing the one or more determined operating parameters of the flow generator to one or more reference values. The flow generator is preferably a rotationally driven flow generator. The electronic data processing device is preferably designed to determine the current volume flow by comparing the current speed of the flow generator to a reference speed of the flow generator. The electronic data processing device is preferably designed to determine the current volume flow by comparing the current consumption of the flow generator to a reference current consumption value of the flow generator. The data processing device is preferably designed to determine the current volume flow by comparing the electrical voltage applied to the flow generator to a reference voltage value of the flow generator. The electronic data processing device is preferably designed to determine the current volume flow by comparing the current power consumption of the flow generator to a reference power consumption value of the flow generator.

Furthermore, advantageous is an inventive temperature-control fan that has a temperature-control device by means of which the volume flow can be heated or cooled. The control device is preferably designed to adjust the temperature control performance of the temperature-control device according to the volume flow detected within the detection region. The temperature-control device is preferably an electrical temperature-control device. The temperature-control device can be a heating and/or cooling device. The temperature-control device can comprise one or a plurality of thermoelectric devices.

In one further preferred embodiment of the inventive temperature-control fan, the latter is designed to be operated in accordance with a method according to one of the embodiments described in the foregoing. With respect to the advantages and modifications of the inventive temperature-control fan, reference is made to the advantages and modifications of the inventive method.

The temperature-control fan can be used, for example, in a neck warmer of a vehicle seat or in a vehicle air conditioning system. The vehicle air conditioning system in which the temperature-control fan can be used can be a central or decentral air conditioning system. For example, a head region temperature control is implemented using the air conditioning system. The air conditioning system can be a multi-zone air conditioning system.

### BRIEF DESCRIPTION OF THE DRAWINGS

Preferred embodiments of the invention are explained and described in greater detail in the following using the enclosed drawings.

FIG. 1 is a schematic depiction of one exemplary embodiment of the inventive temperature-control fan; and,

FIG. 2 depicts fan and blower characteristic lines of an inventive temperature-control fan.

### DETAILED DESCRIPTION

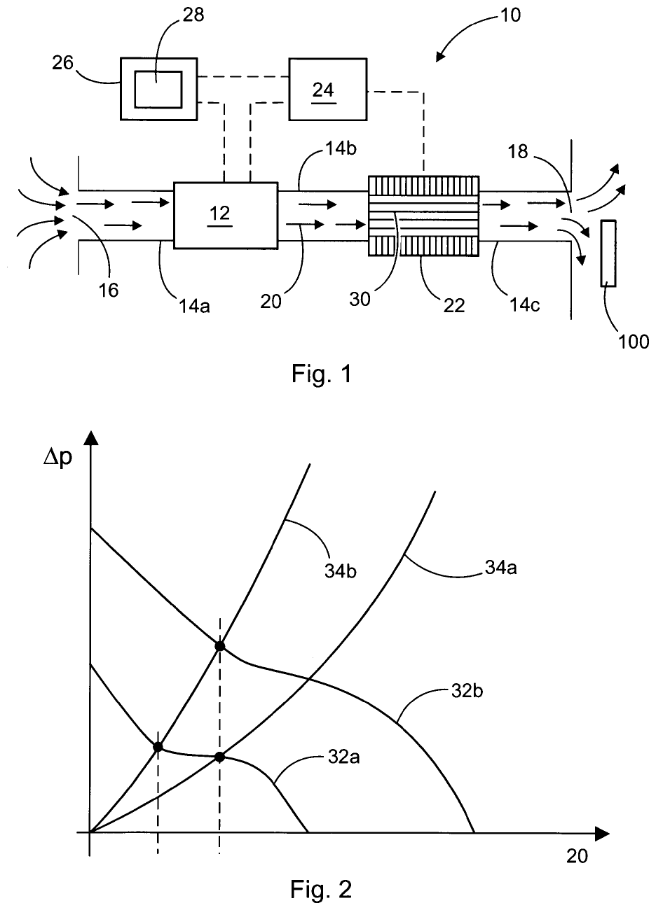

FIG. 1 depicts a temperature-control fan 10 that can be used, for example, as a neck warmer in a motor vehicle seat. The temperature-control fan 10 has a flow generator 12 for generating a volume flow 20 in an air guiding system. The flow generator 12 in this case is embodied as an axial fan. In an alternative embodiment, the flow generator 12 can also be embodied as a radial fan. The air guiding system in which the temperature-control fan 10 is integrated has a plurality of air guiding lines 14a-14c. Ambient air is pulled in via the inlet opening 16 and blown out again via the outlet opening 18 based on the volume flow 20 generated by the flow generator 12.

The temperature-control fan 10 further comprises a temperature-control device 22 by means of which the volume flow 20 can be heated or cooled. The temperature-control device 22 in this case is an electrically operated temperature-control device and can be operated both as a cooling device and as a heating device. Consequently, the air flowing through a temperature-control region of the temperature-control device 22 can be heated and cooled using the temperature-control device. The temperature-control device 22 can comprise, for example, one or a plurality of thermoelectric devices.

The flow generator 12 and the temperature-control device 22 are connected in a signal-conducting manner to the control device 24 of the temperature-control fan 10. A speed can be pre-specified for the flow generator 12 and a temperature can be predefined for the temperature-control device via the control device.

The temperature-control fan 10 furthermore has a detection device 26 for detecting the current volume flow 20 generated by the flow generator 12 within a detection region 30. The detection device 26 is designed to detect a plurality of operating parameters of the flow generator 12 that are dependent on the current flow resistance of the air guiding system.

The flow resistance of the air guiding system can vary during operation of the temperature-control fan 10 due, for example, to an item 100 that is disposed in front of the outlet opening 18. For example, a part of the back or head of a person can be disposed in front of the outlet opening 18 when the temperature-control fan 10 is employed as a neck warmer in a convertible. That is, during operation of the temperature-control fan 10, movements by the person also result in changes in the blockage state to which the operation of the fan must be adapted.

The item 100 or a person disposed in front of the outlet opening 18 causes a partial blockage of the air guiding system, so that there is a fluctuation in the counterpressure in the air guiding system and thus a change in the volume flow within the air guiding system. To avoid excessive overheating of the volume flow 20 when there is partial blockage of the air guiding system, the heating performance of the temperature-control device 22 should be adapted to the changes in the volume flow occurring within the air guiding system.

The detection region 30 for which the detection device 26 calculates the current volume flow 20 is disposed within the temperature-control device 22 so that the temperature-control performance of the temperature-control device 22 can be exactly adapted to the volume flow 20 flowing through the temperature-control device 22.

The detection device 26 comprises an electronic data processing device 28 via which the current volume flow 20 is calculated based on the current speed and current consumption of the flow generator 12. To this end, the electronic data processing 28 compares the current speed of the flow generator 12 to a reference speed for the flow generator 12 and the current consumption of the flow generator 12 to a reference current consumption value for the flow generator 12. The reference values are operating parameters for the flow generator 12 that relate to a free-blowing or unblocked initial operating state of the air guiding system and temperature-control fan 10.

To prevent excessive overheating of the volume flow 20 to be blown out, when there is a partial blockage of the air guiding system the heating performance of the temperature-control device is to be reduced. To this end, the temperature-control device 24 is designed to adjust the temperature control performance of the temperature-control device 22 according to the volume flow 20 detected within the detection region 30.

FIG. 2 illustrates fan characteristic values 32a, 32b and blower characteristic values 34a, 34b from which the interaction between change in pressure Δp and volume flow 20 result. The illustration clarifies that, as an alternative to or in addition to the adaptation in the temperature-control performance of the temperature-control device 22, when there is a partial blockage of the air guiding system it is possible to increase the speed in order to increase the air throughput. The fan characterizing line 32a illustrates the relationship between the overpressure generated by the flow generator 12 and the volume flow generated by the flow generator 12 at 50% of the maximum speed of the flow generator 12. The blower characterizing line 34a illustrates the increase in counterpressure within the air guiding system when the volume flow 20 increases in an unblocked state of the air guiding system. The point of intersection between the fan characterizing line 32a and the blower characterizing line 34a thus indicates the working point for the unblocked state, wherein the speed set on the flow generator 12 is 50% of the maximum speed.

If there is now a partial blockage of the air guiding system, the flow resistance increases so that a new blower characterizing line 34b results.

If the flow generator 12 now continues to be operated at 50% of maximum speed, the volume flow 20 conducted through the temperature-control device 22 decreases so that excessive heating of the volume 20 through the temperature-control device 22 results. If the temperature-control performance of the temperature-control device 22 is retained, the speed of the flow generator 12 can alternatively be increased so that the new fan characterizing line 32b results. The point of intersection of the fan characterizing line 32b and the blower characterizing line 34b represents the new working point, so that the original volume flow 20 is again conducted through the temperature-control device 22.

Thus, the adaptation of the temperature-control performance according to the volume flow 20 detected within the detection region 30 can also be combined with the adaptation of the speed of the flow generator 12 according to the volume flow 20 detected within the detection region 30 in order to compensate for fluctuations in counterpressure due to partial blockage of the air outlet 18.

### REFERENCE SYMBOLS

10 Temperature-control fan
12 Flow generator
14a-14c Air guiding lines
16 Inlet opening
18 Outlet opening
20 Volume flow
22 Temperature-control device
24 Control device
26 Detection device
28 Data processing device
30 Detection region
32a, 32b Fan characteristic lines
34a, 34b Blower characteristic lines
100 Item
Δp Change in pressure

1. A method for operating a temperature-control fan that is integrated in an air guiding system, the method comprising:
determining a current volume flow generated by a flow generator of the temperature-control fan within a detection region, and
adjusting at least one operating parameter of the temperature-control fan according to the current volume flow determined within the detection region.

2. The method according to claim 1, wherein the method comprises:
determining one or more operating parameters of the flow generator that are dependent on a current flow resistance of the air guiding system,
wherein the current volume flow is determined based on one or more determined operating parameters of the flow generator.

3. The method according to claim 2, wherein the current volume flow is determined by comparing the one or more determined operating parameters of the flow generator to one or more reference values.

4. The method according to claim 2, wherein the flow generator is driven in a rotational manner, and one of the one or more operating parameters is a current speed of the flow generator.

5. The method according to claim 2, wherein
the current generator is driven electrically, and one of the one or more operating parameters of the flow generator include:
a current consumption of the flow generator;
an electrical voltage applied to the flow generator;
a current power consumption of the flow generator; and/or,
a current temperature of supplied air in the flow generator.

6. The method according to claim 1, wherein the adjusting step comprises:
adapting a temperature-control performance of a temperature-control device of the temperature-control fan; and/or,
adapting a speed of the flow generator.

7. The method according to claim 2, wherein the method comprises:
detecting when a flow resistance limit and/or a counterpressure limit is exceeded based on the one or more operating parameters of the flow generator.

8. A temperature-control fan comprising:
a flow generator for generating a volume flow in an air guiding system;
a detection device for detecting a current volume flow generated
by the flow generator within a detection region; and
a control device to adjust at least one operating parameter of the temperature-control fan according to the current volume flow detected within the detection region.

9. The temperature-control fan according to claim 8, wherein
the flow generator is a radial fan or an axial fan.

10. The temperature-control fan according to claim 8,
the detection device is configured to detect one or more operating parameters of the flow generator that are dependent on current flow resistance of the air guiding system, wherein the detection device comprises an electronic data processing device configured to determine the current volume flow based on the one or more determined operating parameters of the flow generator.

11. The temperature-control fan according to claim 10, wherein
the electronic data processing device is configured to determine the current volume flow by comparing the one or more operating parameters of the flow generator to one or more reference values.

12. The temperature-control fan according to claim 8, wherein,
a temperature-control device by means of which the volume flow can be heated or cooled,
wherein the control device is configured to adjust temperature-control performance of the temperature-control device according to the volume flow detected within the detection region.

13. A method of operating the temperature-control fan according to claim 8, wherein the method comprises:
determining a current volume flow generated by a flow generator of the temperature-control fan within a detection region, and
adjusting at least one operating parameter of the temperature-control fan according to the current volume flow determined within the detection region.
